(19) United States
(12) Patent Application Publication
(10) Pub. No.: US 2025/0104534 A1
(43) Pub. Date: Mar. 27, 2025

(54) LOTTERY TICKET SYSTEM INCLUDING LOTTERY TERMINAL LINKED TO POINT-OF-SALE SYSTEM

(71) Applicant: IGT Global Solutions Corporation, Providence, RI (US)

(72) Inventors: Apostolos D. Kallis, Barrington, RI (US); Michael Roeygaard, Rome (IT)

(21) Appl. No.: 18/471,518

(22) Filed: Sep. 21, 2023

(51) Int. Cl. G07F 17/32; G06Q 20/20

(52) U.S. Cl. CPC G07F 17/329; G06Q 20/20

(57) ABSTRACT

A lottery terminal for a point-of-sale system, and systems and methods employing such lottery terminal with a point-of-sale system terminal of a point-of-sale system that enables the activation, purchase, validation, and/or redemption of lottery tickets through the combination of the lottery terminal and the point-of-sale system terminal of the point-of-sale system.

### BACKGROUND

The present disclosure relates to a lottery ticket system including a lottery terminal linked to a point-of-sale system that enables purchases and redemptions of lottery tickets.

Lottery tickets such as instant lottery tickets have substantial variations in the structures, configurations, and arrangements of the individual components of inventory control numbers and barcodes for such lottery tickets. These variations occur on a jurisdictional basis and on a manufacturer basis. This wide variety of the structures, configurations, and arrangements of the individual components of the inventory control numbers and barcodes for lottery tickets limits the types of systems that can be used to activate, sell, validate, and redeem such lottery tickets. For example, various point-of-sale systems commercially employed by wholesalers and retailers are not configured to activate, sell, validate, or redeem lottery tickets.

### BRIEF SUMMARY

In various embodiments, the present disclosure relates to a lottery terminal configured to be communicatively and operably connected to a POS system terminal of a POS system, wherein the lottery terminal includes: a housing; a scanner connector supported by the housing and configured to enable the lottery terminal to be communicatively connectable to a lottery terminal scanner; a POS system connector supported by the housing and configured to enable the lottery terminal to be communicatively connectable to the POS system terminal; a data transmitter supported by the housing; a data receiver supported by the housing; a processor supported by the housing and communicatively connected to the scanner connector, the POS system connector, the data transmitter, and the data receiver; and a memory device supported by the housing.

In various other embodiments, the present disclosure relates to a lottery terminal configured to be communicatively and operably connected to a POS system terminal of a POS system, wherein the lottery terminal includes: a housing; a display device supported by the housing; a scanner connector supported by the housing and configured to enable the lottery terminal to be communicatively connectable to a lottery terminal scanner; a POS system connector supported by the housing and configured to enable the lottery terminal to be communicatively connectable to the POS system terminal; a data transmitter supported by the housing; a data receiver supported by the housing; a processor supported by the housing and communicatively connected to the scanner connector, the POS system connector, the data transmitter, and the data receiver; and a memory device supported by the housing. The memory device stores a plurality of instructions that when executed by the processor, cause the lottery terminal to: receive scan data from a scan by the lottery terminal scanner; responsive to the scan data not including lottery ticket related data, cause a display, by the display device, of an error message; and responsive to receiving the scan data including lottery ticket related data, determine UPC data associated with the lottery ticket, and create and transmit the UPC data for the lottery ticket to the POS system terminal.

In various other embodiments, the present disclosure relates to a lottery terminal configured to be communicatively and operably connected to a POS system terminal of a POS system, wherein the lottery terminal includes: a housing; a display device supported by the housing; a scanner connector supported by the housing and configured to enable the lottery terminal to be communicatively connectable to a lottery terminal scanner; a POS system connector supported by the housing and configured to enable the lottery terminal to be communicatively connectable to the POS system terminal; a data transmitter supported by the housing; a data receiver supported by the housing; a processor supported by the housing and communicatively connected to the scanner connector, the POS system connector, the data transmitter, and the data receiver; and a memory device supported by the housing. The memory device stores a plurality of instructions that when executed by the processor, cause the lottery terminal to: receive scan data from a scan by the lottery terminal scanner; responsive to the scan data not including lottery ticket related data, cause a display, by the display device, of an error message; and responsive to receiving the scan data including lottery ticket related data, and responsive to receipt of confirmation of activation of the lottery ticket by a central lottery system, transmit the UPC data for the lottery ticket to the POS system terminal.

Additional features are described in, and will be apparent from, the following Detailed Description and the figures.

### BRIEF DESCRIPTION OF THE SEVERAL VIEWS OF THE DRAWINGS

FIG. 1 is a diagrammatic view of a lottery terminal linkable to a point-of-sale system terminal of a point-of sale system in accordance with one example embodiment of the present disclosure.

FIG. 2 is a diagrammatic view of a lottery ticket system including a lottery terminal linked to a point-of-sale system terminal of a point-of-sale system in accordance with one example embodiment of the present disclosure.

FIG. 3 is a diagrammatic view of a lottery ticket system including a lottery terminal linked to a point-of-sale system terminal of a point-of-sale system in accordance with another example embodiment of the present disclosure.

FIG. 4 is a diagrammatic view of a lottery ticket system including a lottery terminal linked to a point-of-sale system terminal of a point-of-sale system in accordance with another example embodiment of the present disclosure.

FIG. 5 is a diagrammatic view of a lottery ticket system including a lottery terminal linked to a point-of-sale system terminal of a point-of-sale system in accordance with another example embodiment of the present disclosure.

### DETAILED DESCRIPTION

In various embodiments, the present disclosure relates to a lottery ticket system including a lottery terminal linkable to a point-of-sale system terminal (referred to herein as a “POS system terminal”) of a point-of-sale system (referred to herein as a “POS system”), and methods employing such lottery terminal with the POS system terminal of the POS system that enable the activation, sale, validation, and redemption of lottery tickets via the combination of the lottery terminal and the POS system terminal.

Instant lottery tickets and draw lottery tickets are employed as example lottery tickets herein; however, it should be appreciated that the present disclosure is not meant to be limited by such examples. For a better understanding of the present disclosure, example instant lottery tickets are first briefly described below, and then example draw lottery tickets are then briefly described below.

Various known instant lottery tickets are single game instant lottery tickets. An example single game instant lottery ticket includes: (1) a ticket substrate; (2) a front surface of the ticket substrate; (3) a predefined scratch-off area defined on the front surface; (4) a scratch-off coating (“SOC”) covering variable lottery game indicia printed on the predefined scratch-off area; (6) a back surface of the ticket substrate; and (7) variable instant lottery ticket information indicia printed on the back surface. The instant lottery ticket information indicia can include text, one or more ticket numbers, one or more ticket barcodes, and other instant lottery ticket information that is either or both human readable and machine readable. Certain of the instant lottery ticket information identifies the instant lottery ticket, the set, the run, and/or the pack of the instant lottery tickets that this instant lottery ticket is/was part of, and can provide other inventory control information. Various known instant lottery tickets include multiple predefined scratch-off areas, multiple sets of variable lottery game indicia printed on the predefined scratch-off areas, and multiple SOCs covering the variable lottery game indicia sets.

Various instant lottery tickets include a variable human readable inventory control number, associated machine-readable barcode, and legal text printed on the back surface. The inventory control number can include: (1) a three-digit game identifying number; (2) a six-digit pack number; (3) a one-digit check number; and (4) a three-digit ticket number, that together uniquely identify this instant lottery ticket from a pack of instant lottery tickets. The instant ticket's barcode can also represent corresponding identical data. All of this data in both machine and human readable formats specifically only provide limited information regarding the instant lottery ticket. The instant ticket inventory control data on the back of the instant lottery ticket are readable prior to purchase of the instant lottery ticket. This readability enables lottery system warehouse storage, picking, shipping, pack activation, purchase, and redemption of such instant lottery ticket. For security reasons, many lotteries have removed win or loss related information from this visible barcode and placed such information under scratch-off material.

The instant lottery ticket's barcode can be scanned by barcode reading devices but unless those devices are connected to a lottery's instant lottery ticket management system (such as a lottery central system), the devices such as those connected to POS systems cannot process and use the information to enable activation, purchase, validation, and/or redemption of such instant lottery tickets. This is in part due to the varying lengths of the inventory, validation, and check digit information, wherein such information is non-uniform and varies from jurisdiction to jurisdiction, which collectively make it difficult for POS systems to determine how to process and use this data. Additionally, certain lottery tickets have two separate barcodes that are geographically separated on the substrate of the ticket, and which have different barcode formats and encode different data.

Instant lottery tickets are often arranged during manufacture (which includes after complete printing) in instant lottery ticket packs of a static quantity that often varies by price point for storage, for organization, for sorting, for picking, and for shipping to instant lottery ticket sellers (such as instant lottery ticket retailers). The instant lottery ticket packs often include: (1) a stack of instant lottery tickets (that are all of the same type, same size, and same game(s)); and (2) a transparent secure outer wrapping (such as transparent plastic wrapping) around the stack of instant lottery tickets. Such instant lottery ticket packs are often configured such that the back surface of at least one instant lottery ticket is visible through the transparent pack wrapping. Logistical tracking and activation of such instant lottery tickets are accomplished by the grouping of tickets in these packs. There are several reasons for arranging instant lottery tickets in packs. One reason is that instant lottery tickets can be ordered and shipped in packs with the pack being the fundamental unit of reconciliation. Since instant lottery tickets are shipped in packs, the pack is also the fundamental unit of activation on the overall instant lottery ticket system. In other words, individual instant lottery ticket activation is currently done on the pack level instead of the individual ticket level. When a retailer receives a new pack of instant lottery tickets, the retailer must first activate the pack on the instant lottery ticket system before selling any of the instant lottery tickets in that pack. Pack activation thereby enables instant lottery tickets to be shipped via common carrier since un-activated or stolen instant lottery ticket packs can be flagged on the instant lottery ticket system with any instant lottery ticket in that pack designated as invalid if redemption of that instant lottery ticket is attempted.

All of the packs for a given lottery game are logged in a digital ship file by the instant lottery ticket manufacturer and loaded on the instant lottery ticket system prior to the tickets for that lottery game being placed on sale for purchase. The ship file contains a listing of all the manufactured packs identifying (typically by omission) any pack numbers that were destroyed in the manufacturing process. The inventory file for a game is transferred from the ticket manufacturer and loaded into a lottery's instant ticket management system. As a lottery game is placed on sale for purchase, the lottery instant ticket system collects information such as: “pack ‘X’ shipped to retailer ‘Y”, and then “pack ‘X’ was activated,” or “pack ‘X’ was reported as stolen/missing,” etc. Thus, the ship file enables logistical tracking of all manufactured packs for an instant lottery ticket game. The ship file does not contain any win or lose information and cannot be linked to a validation file.

The validation file contains the validation codes for all instant lottery tickets for a lottery game. The validation codes provide pointers to the prize values (if any) of the instant lottery tickets on the instant lottery ticket system. The validation codes are inaccessible on un-played instant lottery tickets due to a portion of the code being covered by SOC. In some versions, the validation code is also embodied as a barcode hidden under the SOC such that it cannot be scanned until the instant lottery ticket is scratched to expose the barcode, and in other versions there is some validation file information in addition to the inventory control information in the ticket back barcode in an encrypted format. Therefore, the security of the system is partly derived from the validation file being unassociated with the ship file as well as the physical un-played ticket's inventory control information. Both the ship and validation files are generated by the ticket manufacturer before the tickets are shipped to a lottery. Lottery logistical and validation systems require the ship and validation files to be loaded on the lottery system prior to instant tickets being shipped to retailers and placed on sale for purchase. Once loaded onto the system, the basic validation file typically cannot be altered (other than flagged additions—e.g., redeemed, stolen, etc.) thereby ensuring the integrity of the instant ticket game and its predetermined payout.

As mentioned above, instant lottery tickets often have substantial variations in the structures, configurations, and arrangements of the individual components of the inventory control numbers and barcodes for such instant lottery tickets. These variations most often occur on a jurisdictional basis and can occur on a manufacturer basis. This wide variety of the structures, configurations, and arrangements of the individual components of the inventory control numbers and barcodes for instant lottery tickets limits the types of systems that can be used to activate, sell, validate, and redeem such instant lottery tickets. For example, the above-described example instant lottery ticket packs must be activated by dedicated lottery terminals prior to purchase of any of the instant lottery tickets in such instant lottery ticket packs. This limits the locations that such instant lottery tickets can be purchased to the locations that have dedicated lottery terminals. For at least the above reasons, various POS systems are not configured to enable activation, sale, validation, and redemption of instant lottery tickets.

A draw lottery ticket can include: (1) a single set of player numbers for a single play of a draw lottery game; (2) multiple sets of player numbers for a single play of a draw lottery game; (3) a single set of player numbers for each of multiple plays of a draw lottery game; or (4) multiple sets of player numbers for each of multiple plays of a draw lottery game. For simplicity, the present disclosure uses a draw lottery ticket with a single set of player numbers for a single play of a draw lottery game as an example, but it should be appreciated that the present disclosure can be employed for purchasing and redeeming such various other draw lottery tickets.

Draw lottery tickets can either be physical or virtual. An example physical draw lottery ticket can include: (1) a ticket substrate; (2) a front surface of the ticket substrate; (3) a single set of player numbers (for a single play of draw lottery game) printed on the front surface of the ticket substrate; (4) a back surface of the ticket substrate; and (5) lottery game and ticket information printed on the front surface of the ticket substrate. This example draw lottery ticket for a single play of a draw lottery game can include a single set of player numbers (i.e., player numbers for the single play of the draw lottery game). It should be appreciated that while this example draw lottery ticket is for a single play, draw lottery tickets often include multiple sets of player numbers that are for a single play of the draw lottery game. The lottery ticket information can include text, one or more ticket numbers, one or more ticket barcodes, and other instant lottery ticket information that is in either or both human readable and machine readable forms. The lottery ticket's barcode is configured to be scanned by a barcode reading device to enable validation and redemption of such draw lottery ticket. Similar to instant lottery tickets, various POS systems are not configured to enable validation and redemption of draw lottery tickets.

Various embodiments of the present disclosure provide a lottery ticket system including a lottery terminal linkable to a POS system terminal of a POS system, and methods employing such lottery terminal with such POS system terminal to enable activation, purchase, validation, and redemption of lottery tickets via such lottery terminal and such POS system terminal without changing the POS system or POS system terminal. The present disclosure enable operators of POS systems to more efficiently stock and sell lottery tickets, and track the sales of such lottery tickets via their POS systems.

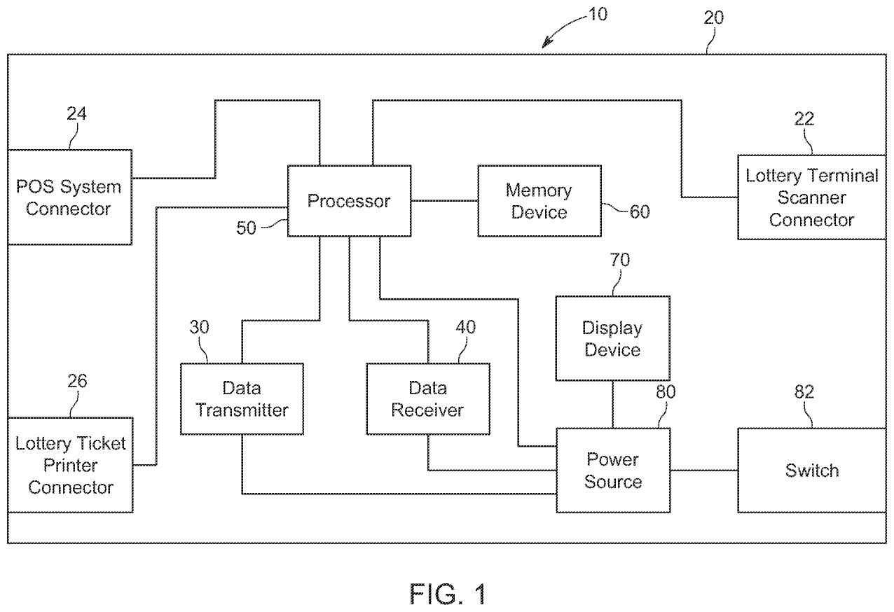

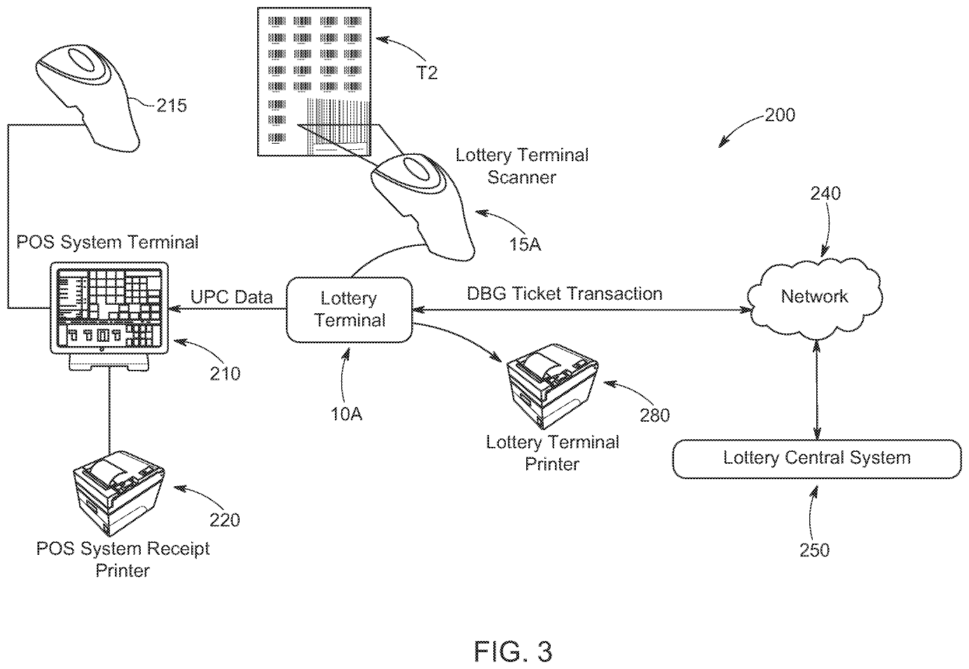

More specifically, FIG. 1 illustrates an example lottery terminal 10 of one example embodiment of the present disclosure that is configured to be communicatively and operably connected to a POS system terminal (and thus linked to the POS system). The example lottery terminal 10 includes: (1) a housing 20; (2) a lottery terminal scanner connector 22; (3) a POS system connector 24; (4) a data transmitter 30; (5) a data receiver 40; (6) a processor 50; (7) a memory device 60; (8) a display device 70 (which can include a touch-screen input device (not shown)); and (9) a power source 80 (and an associated power or mode switch 82). In various embodiments, the lottery terminal 10 can include an internal printer (not shown) or can include a lottery ticket printer connector 26 that enables connection of the lottery terminal to a lottery ticket printer (such as shown in FIG. 3). In various embodiments, the lottery terminal 10 can include an internal scanner and in such case the lottery terminal scanner connector connects such internal scanner and the processor 50.

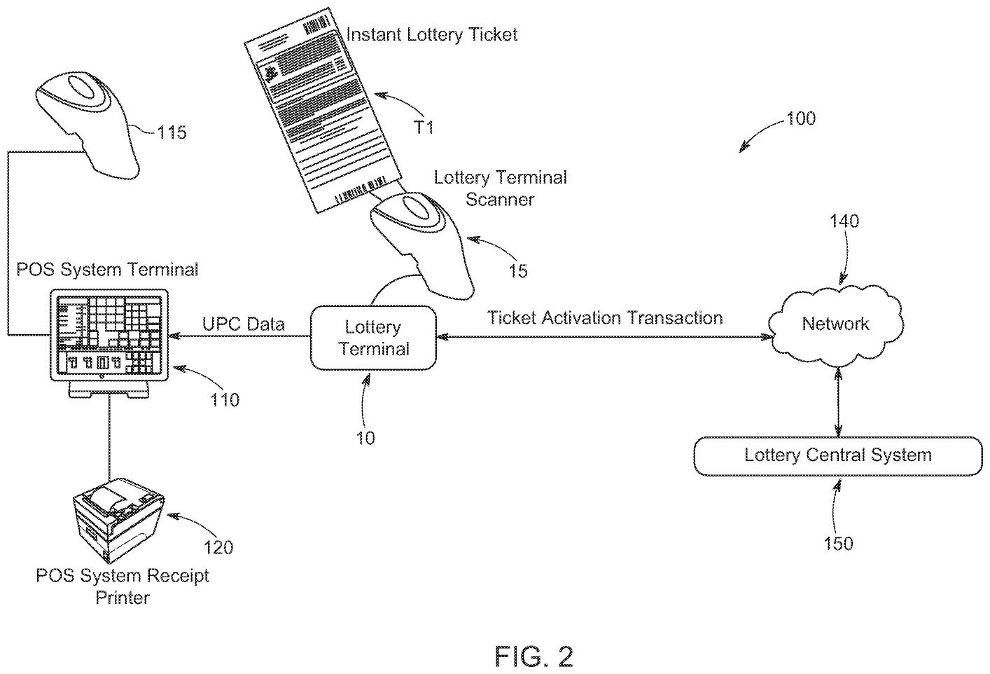

The lottery terminal 10 can be connected to a lottery terminal scanner (such as scanner 15 as shown in FIG. 2) via a hardwire (not labeled) connected at one end to the lottery terminal scanner connector 22 and at the other end to a suitable input connector (not shown) of the lottery terminal scanner. The lottery terminal 10 can be connected to the POS system terminal via a hardwire (not labeled) connected at one end to the POS system connector 24 and at the other end to a suitable input connector (not shown) of the POS system terminal. This lottery terminal 10 is thus configured to be communicatively and operably connected by hardwires to both of a lottery terminal scanner and a POS system terminal of a POS system. The lottery terminal 10 is configured to receive and transmit data in the form of electrical signals or communications in a conventional manner or any new matter subsequently developed. For brevity, the data signals may be referred to herein is data or different types of data as described below. In other embodiments, the lottery terminal can be configured to be communicatively and operably connected to either or both the lottery terminal scanner and/or the POS system terminal wirelessly.

The lottery terminal 10 is generally configured to: (i) receive data from the lottery terminal scanner; (ii) analyze the scan data received from the lottery terminal scanner; (iii) transmit data based on that lottery ticket related data in real time to a lottery central system; (iv) receive lottery ticket data from the lottery central system; and (v) transmit data to the POS system terminal and thus the POS system to enable and facilitate the purchase of a lottery ticket and the tracking of data related to the lottery ticket by the POS system.

More specifically, the housing 20 provides a suitable compartment for supporting various components of the lottery terminal 10 in a compact and durable manner. The housing 20 can be configured in any suitable manner.

The lottery terminal scanner connector 22 is supported by the housing 20, connected to the processor 50, and is configured facilitate connection of the lottery terminal to a lottery terminal scanner (such as via a plug connected to a wire extending from the lottery terminal scanner). The lottery terminal scanner connector 22 is configured to facilitate the receipt of scan data from the lottery terminal scanner after the lottery terminal scanner scans a code (such as a barcode) on a lottery ticket information provider and provide that scan data to the processor 50. For purposes of this disclosure, as further explained below, a lottery ticket information provider can be a lottery ticket itself or a provider of information relating to a lottery ticket. In various alternative embodiments, the lottery terminal scanner is physically part of the lottery terminal (such as the housing thereof) and is not physically separate from the lottery terminal or lottery terminal housing. In such case, the lottery terminal scanner connector 22 provides the electrical connection between such components. It should be appreciated that while the various example embodiments of the present disclosure describe such components as separate physical components, such example embodiments are not meant to limit the present disclosure and such functions can be provided by a lottery terminal that includes the lottery terminal scanner.

The POS system connector 24 is supported by the housing 20, connected to the processor 50, and is configured to be connected a POS system terminal (such as via a wire plugged into the POS system terminal and plugged into the POS system connector 24). The POS system connector 24 is configured to facilitate the transmission of lottery ticket data to the POS system terminal. The lottery ticket data can be based on data received by the lottery terminal 10 from the lottery terminal scanner and/or a lottery central system or other suitable lottery ticket data. In various embodiments, the POS system connector 24 of the lottery terminal 10 can include a wire connected to the housing 20 and a plug at the end of the wire that is configured to be connected to the POS system terminal.

The data transmitter 30 and the data receiver 40 are supported by the housing 20, connected to the processor 50, and can be any suitable combined device or separate devices that is/are configured to communicate data on a real time basis with the lottery central system (such as via a suitable data network), the POS system terminal, or other suitable devices.

The processor 50 and the memory device 60 are supported by the housing 20 and can be any suitable combined device or separate devices that is/are configured to process data on a real time basis and to control certain of the components of the lottery terminal 10 such as discussed herein. The processor can include one or more suitable processing devices such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. The memory device can include one or more suitable memory devices such as, but not limited to, read-only memory, random-access memory, one or more digital registers, cache memory, one or more semiconductor memory devices, magnetic media such as integrated hard disks and/or removable memory, magneto-optical media, and/or optical media. The memory device stores instructions executable by the processor to control operation of the lottery terminal 10 such as described herein.

In various embodiments, the memory device stores computer program instructions may be provided to the processor, such that the instructions, which execute via the processor of the computer or other programmable instruction execution apparatus, create a mechanism for implementing various functions/acts specified in the present disclosure. These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified herein. The computer program instructions may also be loaded onto a computer, other programmable instruction execution apparatus, or other devices to cause a series of operational steps to be performed on the computer, other programmable apparatuses, or other devices to produce a computer implemented process such that the instructions which execute on the computer or other programmable apparatus provide processes for implementing the functions/acts specified herein.

In the embodiments that include the display device 70, the display device 70 is supported by the housing 20, connected to the processor 50, and configured to display various information regarding the lottery terminal 10 under the control of the processor 50. The displayed information can include the different states, modes, messages (such as error messages), or other operating conditions of the lottery terminal 10, or can be related to the data processed by the lottery terminal 10. In the alternative embodiments that include the status indicator(s), each such status indicator is supported by the housing 20, connected to the processor 50, and configured to indicate various information regarding the lottery terminal 10 under the control of the processor 50. The indicator(s) can indicate different states, modes, messages, or other operating conditions of the lottery terminal 10, or can be related to the data processed by the lottery terminal 10.

The power source 80 and the power and/or mode switch 82 are supported by the housing 20 and can be any suitable power source and switch(es) that function to provide electrical power to the various components of the lottery terminal 10, the turn the lottery terminal 10 on and off, and/or change modes of the lottery terminal 10. The quantity of switches can vary in accordance with the present disclosure.

FIG. 2 illustrates a system 100 (and related method) employing a lottery terminal 10 with a lottery central system 150, a lottery terminal scanner 15, a POS system terminal 110 of a POS system (not fully shown), a POS system scanner 115, and a POS system receipt printer 120 in accordance with a first example embodiment of the present disclosure. In this example embodiment, the lottery ticket information provider is a scratch off instant lottery ticket T1 and the lottery ticket system 100 facilitates the purchase of this scratch off instant lottery ticket T1. In this example, a single operator can operate the lottery terminal 10 and the POS system terminal 110.

In this example, for a non-lottery ticket related product purchase for a customer, the operator can use the POS system scanner 115 for that product purchase. This use is standard and is not further explained herein for brevity. Also, in this example, for a lottery ticket related product purchase (or redemption) for the same customer, the operator can use the lottery terminal scanner 15 for that lottery ticket purchase (or redemption).

In operation of this example embodiment, the operator can use the lottery terminal scanner 15 to scan the I2of5 barcode (that contains Game/Pack/Ticket ID) of the instant lottery ticket T1 that a customer has indicated that the customer wants to buy. Such instant lottery tickets can be maintained and displayed close to the lottery terminal 10 or in another suitable location. It should be appreciated that such instant lottery tickets can be activated on a pack or on a ticket level as discussed herein. The lottery terminal 10 monitors the scan data from scans by the lottery terminal scanner 15 and reacts when lottery ticket related data (including the I2of5 content) is received from the lottery terminal scanner 15. Specifically, responsive to receiving lottery ticket related data (including the I2of5 content), the lottery terminal 10 decodes the lottery ticket related data (including the I2of5 content) and creates in real time ticket activation request data based on the I2of5 content. The lottery terminal 10 transmits via the data transmitter 30 (and via a suitable data network 140) in real time the ticket activation request data to the lottery central system 150. The lottery central system 150 processes the ticket activation request data and creates in real time ticket activation response data. The lottery central system 150 also updates the lottery ticket status to activated in its systems (assuming the lottery ticket activation request data relates to a valid lottery ticket). The lottery terminal 10 waits for the ticket activation response data from the lottery centra system 150 before it sends a UPC code to the POS system terminal 110. The ticket activation response data can either include a ticket activation confirmation or a ticket activation denial. The lottery central system 150 transmits in real time (and via the suitable data network 140) the ticket activation response data to the data receiver 40 of the lottery terminal 10. Responsive to receiving the ticket activation response data, the lottery terminal 10 determines in real time if the ticket activation response data includes a ticket activation confirmation or a ticket activation denial. If the ticket activation response data includes a ticket activation denial, the lottery terminal 10 does not send a UPC code to the POS system terminal 110. Rather, the lottery terminal 10 displays via its display device 70 an error message (that can include a suitable error code) and such that the operator can indicate the error or issue to the customer and address such error or issue in a suitable manner. If the ticket activation response data includes a ticket activation confirmation, the lottery terminal 10 looks up in its memory device 60 the UPC code associated with this instant lottery ticket T1 based on the Game Identification (“ID”) it has stored and creates and transmits UPC data for this instant lottery ticket T1 to the POS system terminal 110. Responsive to receipt of this UPC data for this instant lottery ticket T1, the POS system terminal 110 adds a lottery sale to the POS shopping cart that it created for the customer in a conventional manner. The operator obtains payment for all items in this POS shopping cart for the customer (including such instant lottery ticket) and provides the customer with the instant lottery ticket T1 and a receipt printed by the POS system receipt printer 120.

In this example embodiment, if the scan data received by the lottery terminal 10 from the lottery terminal scanner 15 does not include lottery ticket related data, the lottery terminal 10 can display via its display device 70 an error message that indicates the error. This error can occur if the operator inadvertently uses the lottery terminal scanner 15 instead of the POS system scanner 115 for scanning a product that is not lottery ticket related. In alternative embodiments, if the scan data received by the lottery terminal 10 from the lottery terminal scanner 15 does not include lottery ticket related data, the lottery terminal 10 can be configured to relay or otherwise transmit that scan data to the POS system terminal 110, and the POS system terminal 110 can then process that scan data in a conventional manner.

In this example embodiment, the memory device 60 stores data regarding the UPC codes for the instant lottery ticket T1 (and other lottery tickets) available at the location of the POS system. In various embodiments, obtaining this data can be part of initiation and/or update processes between the lottery terminal 10 and the lottery central system 150. In various embodiments, the lottery system and the retailer will agree on the respective different UPC codes that the lottery terminal 10 will provide to the lottery system terminal 110 for all of the different types of lottery tickets that will be sold by such retailer. In various embodiments, the retailer will be responsible for ensuring all such UPC codes (and related definitions) are loaded into or otherwise known by POS system, and the lottery system and/or the retailer can have a suitable tool to update the POS system with the same UPC codes (and related definitions).

In the above example embodiment, the instant lottery ticket T1 from the pack of instant lottery tickets that contains the instant lottery ticket T1, is activated at the time of purchase (on a ticket by ticket basis) and the pack of such instant lottery tickets does not need to be activated before such purchase of the instant lottery ticket T1.

In various other embodiments, lottery ticket pack activation for a pack of instant lottery tickets (and other pack management activities by retailers) can be preformed prior to the purchase of any such lottery tickets from the pack via another system that enables retailers access to manage and administrate the lottery category for reporting, invoicing, ordering, communications etc. This can include the ability to order more instant lottery tickets, and can support lottery ticket pack management including pack activation.

In various other example embodiments, before allowing a customer to purchase any instant lottery tickets from a pack of instant lottery tickets, the lottery terminal 10 and lottery terminal scanner 15 can be used by an operator to activate the pack of instant lottery tickets. This can be done in any suitable manner such as in the following example manner. In this example manner, the lottery terminal 10 has a pack activation mode and the operator can place the lottery terminal 10 in this pack activation mode. In this pack activation mode, the operator can use the lottery terminal scanner 15 to scan the I2of5 barcode (that contains Game/Pack/Ticket ID) of one of the instant lottery tickets in a pack. In this pack activation mode, the lottery terminal 10 monitors the scan data from scans by the lottery terminal scanner 15 and reacts and responsive to receiving lottery ticket related data (including I2of5 content). Specifically, the lottery terminal 10 decodes the I2of5 content and creates in real time ticket pack activation request data based on the I2of5 content. The lottery terminal 10 transmits via the data transmitter 30 (and via the suitable data network 140) in real time the ticket pack activation request data to the lottery central system 150. The lottery central system 150 processes the ticket pack activation request data and creates in real time ticket pack activation response data. The lottery central system verifies that this ticket pack activation request data came from the correct receiver of this pack of instant lottery tickets and creates ticket pack activation response data. The ticket pack activation response data can either include a ticket pack activation confirmation or a ticket pack activation denial. The lottery central system 150 transmits the ticket pack activation response data to the data receiver 40 of the lottery terminal 10. Responsive to receiving the ticket pack activation response data, the lottery terminal 10 determines in real time if the ticket pack activation response data includes a ticket pack activation confirmation or a ticket pack activation denial. If the ticket pack activation response data includes a ticket activation denial, the lottery terminal 10 displays via its display device 70 an error message (that can include a suitable error code) such that an operator can indicate the error or issue to address such error or issue in a suitable manner. If the ticket pack activation response data includes a ticket pack activation confirmation, the lottery terminal 10 displays via its display device 70 a confirmation to the operator that the ticket pack has been activated. Thereafter, the instant lottery tickets in that pack are ready for purchase, and for each such instant lottery ticket from the pack, the lottery terminal 10 does not need to obtain activation approval from the central lottery system 150. In various embodiments, this activation or non-activation of the lottery ticket pack is not communicated to the POS system because such data is not relevant for the POS system. In various embodiments, this activation or non-activation of the lottery ticket pack is communicated to the POS system for lottery ticket and lottery ticket pack inventory control data and tracking.

FIG. 3 illustrates a system 200 (and related method) employing a lottery terminal 10A and a lottery terminal scanner 15A with a lottery central system 250, a POS system terminal 210, a POS system scanner 215, and a POS system receipt printer 220 in accordance with a second example embodiment of the present disclosure. In this example embodiment, the lottery ticket information provider is a pre-printed draw lottery ticket DBG price sheet T2 (for a draw-based game) that includes a plurality of different UPC codes for a plurality of different draw lottery tickets for a plurality of different draw lottery games (and purchase prices for such draw lottery tickets). In various embodiments, each different lottery game and each different price point for such draw lottery game has a different UPC code associated therewith. The system 200 facilitates the purchase of these draw lottery tickets.

In this example, for a non-lottery ticket related product purchase for a customer, the operator can use the POS system scanner 215 for that product purchase. This use is standard and is not further explained herein for brevity. Also, in this example, for a lottery ticket related product purchase or redemption for the same customer, the operator can use the lottery terminal scanner 15A for that lottery ticket purchase or redemption.

In operation of this example embodiment, the operator of the POS system terminal 210 and the lottery terminal 10A uses the lottery terminal scanner 15A to scan the respective UPC barcode of the draw lottery ticket DBG price sheet T2 corresponding to a draw lottery ticket that a customer has indicated that the customer wants to purchase. Such draw lottery ticket DBG price sheet T2 can be maintained and displayed close to the lottery terminal 10A or in another suitable location. In other embodiments, other methods for the DBG UPC code scanning can be employed. For example, the a playcard that has the draw lottery game and purchase price with a barcode printed for operator to scan the UPC can be employed. The lottery terminal 10A monitors the scan data from scans by the lottery terminal scanner 15A for lottery ticket related data (including this UPC barcode). Specifically, responsive to receiving lottery ticket related data (including this UPC barcode), the lottery terminal 10A creates in real time draw game wager request data based on this UPC barcode. The lottery terminal 10A transmits (via a suitable data network 240) in real time the draw game wager request data to the lottery central system 250. The lottery central system 250 processes the draw game wager request data and creates in real time draw game wager response data. In various embodiments, the lottery system processes the wager as any other wager request from a 3rd party system. In various embodiments, a front-end/gateway system can be employed to enable 3rd party systems to transact with the lottery central system. The draw game wager response data can either include a wager confirmation or a wager denial. The lottery central system 250 transmits (via the suitable data network 240) in real time the draw game wager response data to the lottery terminal 10A. Responsive to receiving the draw game wager response data, the lottery terminal 10A determines in real time if the draw game wager response data includes a wager confirmation or a wager denial. If the draw game wager response data includes a wager denial, the lottery terminal 10A displays via its display device an error message (that can include a suitable error code) such that an operator can indicate the error or issue to address such error or issue in a suitable manner. If the draw game wager response data includes a wager confirmation, the lottery terminal 10A causes the lottery terminal printer 280 to print the draw lottery ticket and transmits the UPC code for this draw lottery ticket to the POS system terminal 210. The POS system terminal 210 adds this lottery sale to the POS shopping cart that it created for the customer. The operator of the POS system terminal 210 obtains payment for all items in the POS shopping cart for the customer and provides the customer with the printed lottery ticket and a receipt printed by the POS system receipt printer 220.

In this example embodiment, if the scan data received by the lottery terminal 10A from the lottery terminal scanner 15A does not include lottery ticket related data, the lottery terminal 10 can display via its display device an error message that indicates the error. This error can occur if the operator inadvertently uses the lottery terminal scanner 15A instead of the POS system scanner 215 for scanning a product that is not lottery ticket related. In alternative embodiments, if the scan data received by the lottery terminal 10A from the lottery terminal scanner 15A does not include lottery ticket related data, the lottery terminal 10A can relay or otherwise transmit that scan data to the POS system terminal 210, and the POS system terminal 210 can then process that scan data in a conventional manner.

In various example embodiments, either the lottery terminal 10A or the lottery central system 250 can determine the symbols (such as the numbers) for the draw lottery ticket. In one example, the numbers for a play of a quick pck DBG lottery ticket can be determined by the lottery terminal 10A and sent to the lottery central system 250 as part of the draw game wager request data. In another example, the numbers for a play of a quick pck DBG lottery ticket can be determined by the lottery central system 250 and can be part of the draw game wager response data. In either case, the lottery terminal 10A can cause the lottery ticket with these numbers to be printed on the connected lottery system printer 280.

In various example embodiments, the lottery terminal 10A and/or the lottery terminal scanner 15A can alternatively be configured to determine the player's numbers for the draw lottery ticket in one or more other suitable manners such as the example manners described below.

In a first example manner, the player can select the player numbers for the draw lottery ticket and the player can fill out a paper play slip with the player's selected numbers. The player hands that play slip to an operator of the lottery terminal 10A and the operator causes uses the lottery terminal scanner 15A (or another scanner of the lottery terminal including a CIS reader) to scan the paper play slip. The lottery terminal scanner creates play slip scan data for the play of the draw lottery game and provides the play slip scan data to the terminal application of the lottery terminal 10A. The terminal application of the lottery terminal 10A interprets and uses that play slip scan data to create a draw lottery ticket including the player numbers. The lottery terminal 10A and specifically the terminal application causes the lottery ticket printer 280 to print out the draw lottery ticket with the player numbers. The lottery terminal 10A also sends this information to the central lottery system 250. The operator of the lottery terminal 10A also collects the payment for the draw lottery ticket via the POS system terminal 210 and provides the printed draw lottery ticket to the player.

In a second example manner for purchasing a draw lottery ticket for a draw lottery game, a player does not select the player numbers for the draw lottery ticket and the player marks a paper play slip with an indication of a requested quick pick for the player numbers. The player hands that play slip to an operator of the lottery terminal 10A and the operator uses the lottery terminal scanner 15A (or another scanner of the lottery terminal including a CIS reader) to scan the paper play slip. The lottery terminal scanner creates play slip scan data for the play of the draw lottery game and provides the play slip scan data to the terminal application of the lottery terminal 10A. The terminal application of the lottery terminal 10A interprets and uses that play slip scan data to create a draw lottery ticket including the player numbers that the lottery terminal 10A randomly selects. The lottery terminal 10A and specifically the terminal application causes the lottery ticket printer 280 to print out the draw lottery ticket with the player numbers. The lottery terminal 10A also sends this information to the central lottery system 250. The operator of the lottery terminal 10A also collects the payment for the draw lottery ticket via the POS system terminal and provides the printed draw lottery ticket to the player.

In a third example manner for purchasing a draw lottery ticket for a draw lottery game, a player does not fill out a paper play slip with the player's selected numbers, but rather the player tells the operator of the lottery terminal 10A that the player wants to purchase a draw lottery ticket using a quick pick for a draw lottery game and the operator inputs that request into the lottery terminal 10A (via an operator interface (not shown in FIG. 1) of the lottery terminal 10A). The lottery terminal 10A randomly determines the player numbers for the player's lottery ticket for the play of the lottery game and uses those numbers to create a draw lottery ticket. The lottery terminal 10A then causes a lottery ticket printer 280 to print out the draw lottery ticket with the player numbers. The lottery ticket printer can be part of the lottery terminal or separate from but connected to the lottery terminal. The lottery terminal 10A also sends this information to the central lottery system 250. The operator of the lottery terminal also collects the payment for the draw lottery ticket and provides the printed draw lottery ticket to the player.

In a fourth example manner for purchasing a draw lottery ticket for a draw lottery game, a player uses a suitable application on a player's computer such as a player mobile electronic device (such as mobile telephone) to fill out an electronic play slip displayed by player computer with the player's selected numbers for the draw lottery game or a quick pick. The application creates a barcode displayable by the display device of the player mobile electronic device. The player causes their mobile electronic device to display the barcode such that the lottery terminal scanner 15A can scan the barcode and create the lottery ticket scan data representing the player numbers or the quick pick for the play of the draw lottery game. The lottery terminal scanner 15A sends the lottery ticket scan data to the lottery terminal, and the terminal application of the lottery terminal 10A uses that lottery ticket scan data to create a draw lottery ticket including the player numbers (respectively either selected by the player or randomly selected by the lottery terminal). The lottery terminal 10A causes the lottery ticket printer 280 to print out the draw lottery ticket with the player numbers. The lottery terminal 10A also sends this information to the central lottery system 250. The operator of the lottery terminal 10A also collects the payment for the draw lottery ticket and provides the printed draw lottery ticket to the player. Alternatively, the central lottery system 250 can provide an electronic draw lottery ticket to the player via the player mobile electronic device.

In a fifth example manner for purchasing a draw lottery ticket for a draw lottery game, a player presents a previous lottery ticket for a draw lottery game for a play it again type draw lottery ticket. The player present that previous lottery ticket for barcode scanning by the lottery terminal scanner 15A to create the lottery ticket scan data representing the player numbers for the play of the draw lottery game. The lottery terminal scanner 15A sends the lottery ticket scan data to the lottery terminal, and the terminal application of the lottery terminal 10A uses that lottery ticket scan data to create a draw lottery ticket including the player numbers. The lottery terminal 10A causes the lottery ticket printer 280 to print out the draw lottery ticket with the player numbers. The lottery terminal 10A also sends this information to the central lottery system 250. The operator of the lottery terminal 10A also collects the payment for the draw lottery ticket and provides the printed draw lottery ticket to the player.

In each of these five example manners, the lottery terminal 10A will determine and transmit the UPC code for the draw lottery ticket to the POS system terminal 210 as indicated above to facilitate payment of for the draw lottery ticket. In certain such embodiments, the lottery terminal 10A will not cause the draw lottery ticket to be printed until the lottery terminal 10A receives a confirmation from the POS system terminal 210 that the draw lottery ticket has been paid for by the customer.

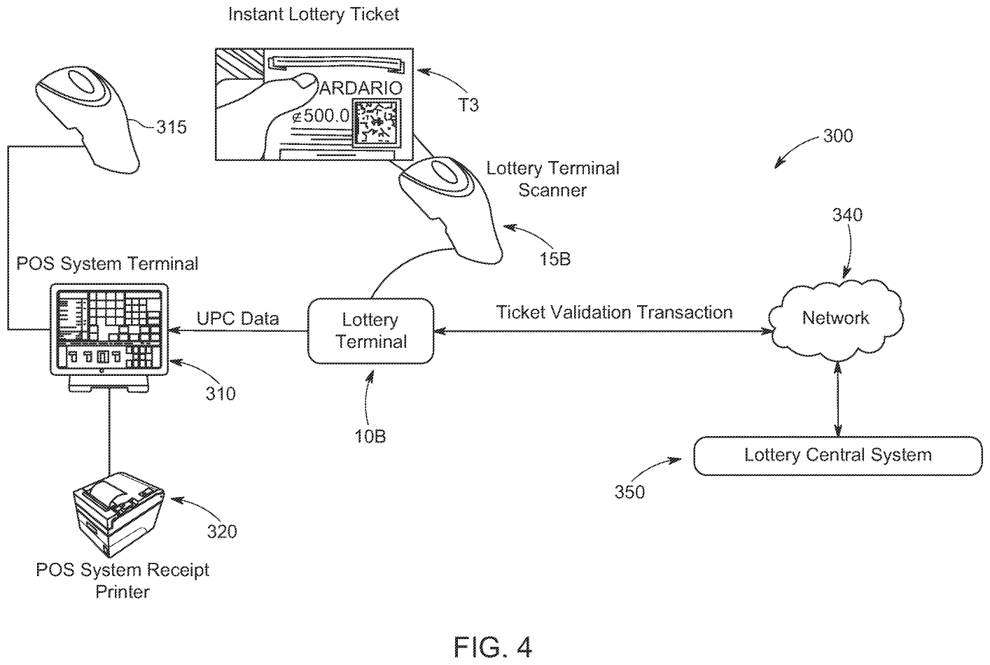

FIG. 4 illustrates a system 300 (and related method) employing a lottery terminal 10B and a lottery terminal scanner 15B with a lottery central system 350, a POS system terminal 310, a POS system scanner 315, and a POS system receipt printer 320 in accordance with a third example embodiment of the present disclosure. In this example embodiment, the lottery ticket information provider is a scratch off instant lottery ticket T3 and the system 300 is configured to validate the instant lottery ticket T3 for redemption (and thus payout of winning amounts to the holder (customer) of the instant lottery ticket T3).

In operation of this example embodiment, an operator uses the lottery terminal scanner 15B to scan the ticket redemption (PDF417) barcode of the instant lottery ticket T3 that a customer has indicated that the customer wants to redeem. The lottery terminal 10B receives the scanned lottery ticket redemption related data from the lottery terminal scanner 15B. Specifically, responsive to receiving lottery ticket redemption related data, the lottery terminal 10B decodes the lottery ticket redemption data and creates in real time ticket redemption request data based thereon. The lottery terminal 10B transmits (via a suitable data network 340) in real time the ticket redemption request data to the lottery central system 350. The lottery central system 350 processes the ticket redemption request data and creates in real time ticket redemption response data. The lottery central system 350 verifies the status and prize of lottery ticket and provides the relevant response as well as updates the status of lottery ticket in it database(s). The ticket redemption response data can include data relating to the instant lottery ticket T3 indicating regarding such ticket one of the following categories: (1) no win, (2) low-tier win amount, (3) mid-tier win amount, and (4) high-tier win amount. The ticket redemption response data can include for each of the low-tier win amount and the mid-tier win amount, a respective amount to be paid to the customer. The ticket redemption response data can include for the high-tier win amount an amount won by the customer, that the customer must seek payment in an alternative manner from the lottery system.

The lottery central system 350 transmits (via the suitable data network 340) in real time the ticket redemption response data to the lottery terminal 10B. Responsive to receiving the ticket redemption response, the lottery terminal 10B determines in real time one of four different UPC codes. Each different code corresponds to a different on of the following categories: (1) no win, (2) low-tier win amount, (3) mid-tier win amount, and (4) high-tier win amounts. As indicated above, this ticket redemption response can include data regarding the prize amounts to be paid to the customer. This can be performed in different manners in accordance with the present disclosure.

The lottery terminal 10B looks up in its memory device 60 the UPC code corresponding to the respective category of the instant lottery ticket T3 and creates and transmits UPC data for this instant lottery ticket T3 to the POS system terminal 310. In various embodiments, the UPC code type can be configured such that adjustments can be made to the value of the goods per transaction. This is somewhat similar to how some goods like fruits and vegetables with a total weight price scanned at POS system has a variable price when scanned.

Responsive to the UPC code corresponding to the no win category, the POS system terminal 310 can provide a receipt printed by the POS system receipt printer 320 but does not provide the customer any pay-out for this instant lottery ticket T3.

Responsive to the UPC code corresponding to the low-tier win amount, the POS system terminal 310 adds a lottery ticket credit to the POS shopping cart if the UPC code corresponds to the low-tier win amount. The operator of the POS system terminal 310 can provide a payment to the customer (depending on all items in the POS shopping cart for the customer) and can provide a receipt printed by the POS system receipt printer 320. The receipt can be part or or a separate shopping checkout receipt (such as a receipt printed at checkout on the POS system).

Responsive to the UPC code corresponding to the mid-tier win amount, the POS system terminal 310 adds a lottery ticket credit to the POS shopping cart if the UPC code corresponds to the mid-tier win amount. The operator of the POS system terminal 310 can provide a payment to the customer (depending on all items in the POS shopping cart for the customer) and can provide a receipt printed by the POS system receipt printer 320. In various embodiments, a mid-tier win amount can require approval by more than one operator. The receipt can be part of or a separate shopping checkout receipt (such as a receipt printed at checkout on the POS system).

Responsive to the UPC code corresponding to the high tier win amount, the POS system terminal 310 can provide a receipt printed by the POS system receipt printer 320. The printed receipt can include instructions for the customer for obtaining the high-tier pay-out. In other embodiments, such instructions can be separately provided to the customer.

In this example embodiment, if the scan data received by the lottery terminal 10B from the lottery terminal scanner 15B does not include lottery ticket related data, the lottery terminal 10B can display via its display device 70 an error message that indicates the error. This error can occur if the operator inadvertently uses the lottery terminal scanner 15A instead of the POS system scanner 315 for scanning a product that is not lottery ticket related. In alternative embodiments, if the scan data received by the lottery terminal 10B from the lottery terminal scanner 15B does not include lottery ticket related data, the lottery terminal 10B can relay or otherwise transmit that scan data to the POS system terminal 310, and the POS system terminal 310 can then process that scan data in a conventional manner.

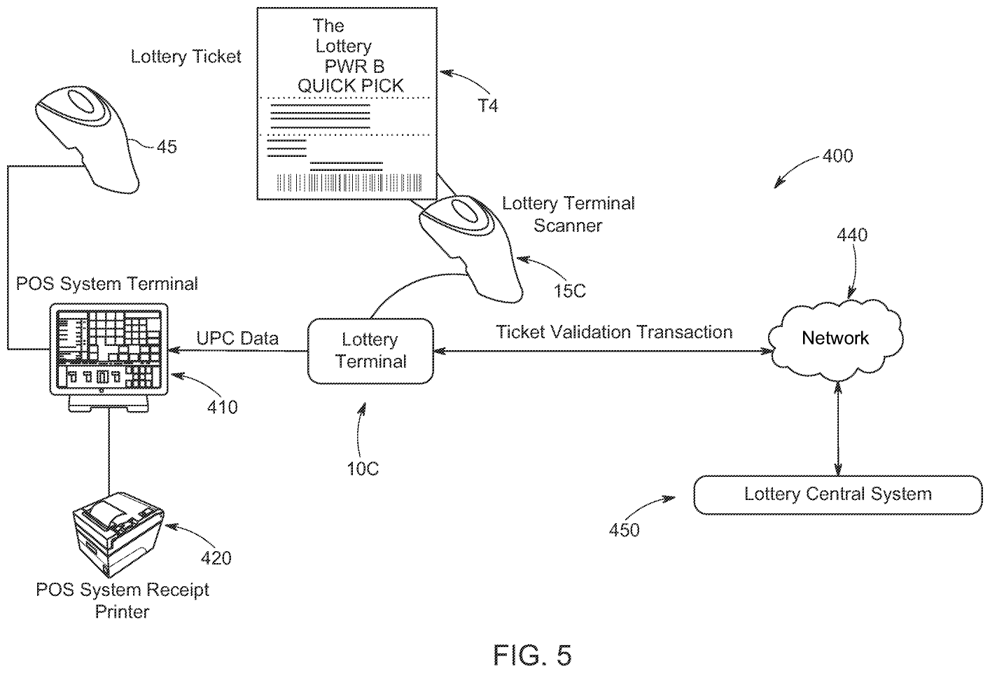

FIG. 5 illustrates a system 400 (and related method) employing a lottery terminal 10C and a lottery terminal scanner 15C with a lottery central system 450, a POS system terminal 410, a POS system scanner 415, and a POS system receipt printer 420 in accordance with a fourth example embodiment of the present disclosure. In this example embodiment, the lottery ticket information provider is a draw lottery ticket T4 and the system 400 is configured to validate the draw lottery ticket T4 for redemption (and thus payout of winning amounts to the holder (customer) of the draw lottery ticket T4).

In operation of this example embodiment, the operator uses the lottery terminal scanner 15C to scan the ticket ID barcode of the draw lottery ticket T4 that the customer has indicated that the customer wants to redeem. The lottery terminal 10C receives the ticket redemption related data from the lottery terminal scanner 15C. The lottery terminal 10C decodes the lottery ticket redemption data and creates in real time ticket redemption request data based thereon. The lottery terminal 10C transmits (via a suitable data network 440) in real time the ticket redemption request data to the lottery central system 450. The lottery central system 450 processes the ticket redemption request data and creates in real time ticket redemption response data. The lottery cental system 450 validates the DBG lottery ticket similar to other draw-based game validations. The ticket redemption response data determine the actions of lottery terminal 10C. The ticket redemption response data can include a ticket redemption response that includes data regarding the ticket indicating one of the following categories: (1) no win; (2) low-tier win amount; (3) mid-tier win amount; and (4) high-tier win amount. As indicated above, this ticket redemption response can include data regarding the prize amounts to be paid to the customer. This can be performed in different manners in accordance with the present disclosure.

The lottery central system 450 transmits (via the suitable data network 440) in real time the ticket redemption response data to the data receiver 40 of the lottery terminal 10C. Responsive to receiving the ticket redemption response data, the lottery terminal 10C determines in real time one of four different UPC codes. Each different code corresponds to a different one of the following categories: (1) no win; (2) low-tier win amount; (3) mid-tier win amount; and (4) high-tier win amount.

The lottery terminal 10C looks up in the memory device 60 the UPC code and creates and transmits UPC data for this draw lottery ticket T4 to the POS system terminal 410.

Responsive to the UPC code corresponding to the no win category, the POS system terminal 410 can provide a receipt printed by the POS system receipt printer 420 but does not provide the customer any pay-out for this draw lottery ticket T4.

Responsive to the UPC code corresponding to the low-tier win amount, the POS system terminal 410 adds a lottery ticket credit to the POS shopping cart if the UPC code corresponds to the low-tier win amount. The operator of the POS system terminal 410 can provide a payment to the customer (depending on all items in the POS shopping cart for the customer) and can provide a receipt printed by the POS system receipt printer 420.

Responsive to the UPC code corresponding to the mid-tier win amount, the POS system terminal 410 adds a lottery ticket credit to the POS shopping cart if the UPC code corresponds to the mid-tier win amount. The operator of the POS system terminal 410 can provide a payment to the customer (depending on all items in the POS shopping cart for the customer) and can provide a receipt printed by the POS system receipt printer 420. In various embodiments, a mid-tier win amount can require approval by more than one operator. The receipt can be part or or a separate shopping checkout receipt (such as a receipt printed at checkout on the POS system.

Responsive to the UPC code corresponding to the high tier win amount, the POS system terminal 410 can provide a receipt printed by the POS system receipt printer 420. The printed receipt can include instructions for the customer for obtaining the high-tier pay-out. In other embodiments, such instructions can be separately provided to the customer.

In this example embodiment, if the scan data received by the lottery terminal 10C from the lottery terminal scanner 15C does not include lottery ticket related data, the lottery terminal 10C can display via its display device an error message that indicates the error. This error can occur if the operator inadvertently uses the lottery terminal scanner 15C instead of the POS system scanner 415 for scanning a product that is not lottery ticket related. In alternative embodiments, if the scan data received by the lottery terminal 10C from the lottery terminal scanner 15C does not include lottery ticket related data, the lottery terminal 10C can relay or otherwise transmit that scan data to the POS system terminal 310, and the POS system terminal 310 can then process that scan data in a conventional manner.

It should be appreciated that the above described embodiments or functions thereof of FIGS. 2, 3, 4, and 5 can be combined in a single system in any manner such that the lottery terminal is configured to perform any set of the functions described above with respect to these different examples. In other words, the lottery terminal and associated scanner can be configured to perform the functions of any two or more or all of the above described embodiments.

In various embodiments, the customer can function as the operator of the POS system where the POS system is configured for self-check-out by the customer. In various such embodiments, certain of the actions described above that are taken by the operator would be taken by the customer to effectuate the purchase of one or more lottery tickets. Such actions can include the scanning actions and the receipt of payment actions (such as via a credit or debit card).

It should be appreciated from the above that the various embodiments of the present disclosure enables a single operator to operate both the lottery terminal and the POS terminal for purchases of one or more non-lottery ticket related products and one or more lottery tickets—in a single consolidated transaction where payment can jointly be made for such products. This eliminates the need for separate financial transactions for the non-lottery ticket related products and for the lottery tickets by a single customer. It should be appreciated from the above that the various embodiments provide a single receipt for both the non-lottery ticket related products and lottery tickets.

It should be appreciated that in the various embodiments of the present disclosure, if an operator inadvertently uses the POS scanner to scan one of the lottery ticket codes, the POS terminal can display a suitable error.

It should be appreciated from the above that the various embodiments of the present disclosure enable the POS system to consolidate tracking of all lottery ticket related purchases along with all non-lottery ticket related purchases, and thus substantially reduce the duplicate accounting related procedures and requirements for such different types of purchases by retailers or wholesalers. In other words, the accounting procedures and requirements for lottery tickets related transactions can be the same as for non-lottery ticket related transactions for those entities.

It should be appreciated from the above that the various embodiments of the present disclosure enable the POS system to track all lottery ticket related purchases along with all non-lottery ticket related purchases and thus substantially consolidate inventory related procedures and requirements. In other words, the inventory tracking and ordering procedures and requirements for lottery tickets related transactions can be the same as for non-lottery ticket related transactions for those entities.

It should be appreciated from the above that the various embodiments of the present disclosure also enable the POS system to track all lottery ticket related redemption related procedures and requirements.

The various example embodiments of the present disclosure additionally provide a series of advantages that enable lottery tickets to be purchased and redeemed via the combination of a lottery terminal and a POS system terminal. These additional advantages include but are not limited to the following advantages: (a) providing a lottery terminal in each checkout lane in a wholesaler facility, a retailer facility, or other facility that enables the POS system therein to be used for payments relating to lottery tickets combined with payments for other products (thus eliminating the need for separate payment transactions); (b) not requiring changes to how operators use POS systems or collect payments from customers using POS systems; (c) providing such devices with limited required additional training by operators in such facilities to use such devices; (d) maintaining security needs for lottery systems and/or the retailer's own network(s); (e) providing for purchase of lottery tickets that are recorded on the POS systems with pre-defined UPC codes for such lottery tickets (that can be different than the UPC codes on such lottery tickets); (f) enabling lotteries and/or retailers to manage UPC code tables on lottery terminals from one or more locations and using one or more tools; (g) generating POS payment receipts that function as payment confirmations for lottery purchases; (h) simplifying retailer or wholesaler accounting in part because all lottery ticket sales and redemptions are recorded via the POS system and facilitate end of shift and end of day reconciliations that are faster and easier; and (i) eliminating the need for the retailer or wholesaler to rely on lottery terminal reports to know how much of POS cash/cashless receipts relate to lottery sales.

It should be appreciated from the above that various embodiments of the present disclosure provide a lottery terminal configured to be communicatively and operably connected to a POS system terminal of a POS system, wherein the lottery terminal comprises: (1) a housing; (2) a scanner connector supported by the housing and configured to enable the lottery terminal to be communicatively connectable to a lottery terminal scanner; (3) a POS system connector supported by the housing and configured to enable the lottery terminal to be communicatively connectable to the POS system terminal; (4) a data transmitter supported by the housing; (5) a data receiver supported by the housing; (6) a processor supported by the housing and communicatively connected to the scanner connector, the POS system connector, the data transmitter, and the data receiver; and (7) a memory device supported by the housing.

In various such embodiments, the lottery terminal includes a printer connector supported by the housing, the printer connector configured to enable the lottery terminal to be communicatively connected to be communicatively connectable to a lottery ticket printer.

In various such embodiments, the memory device stores a plurality of instructions that when executed by the processor, cause the lottery terminal to receive scan data from a scan by the lottery terminal scanner. In various such embodiments, the memory device stores a plurality of instructions that when executed by the processor, cause the lottery terminal to: (a) responsive to receiving from the lottery ticket related scan data related to an instant lottery ticket, create in real time ticket activation request data, and transmit the ticket activation request data to a lottery central system; and (b) responsive to the scan data received by the lottery terminal from the lottery terminal scanner not comprising lottery ticket related data, transmit the scan data to the POS system terminal. In various such embodiments, the lottery ticket related data comprises I2of5 content. In various such embodiments, the memory device stores a plurality of instructions that when executed by the processor, cause the lottery terminal to, responsive to receiving from the lottery central system ticket activation response data comprising a ticket activation confirmation, determine UPC data associated with the instant lottery ticket, and create and transmit the UPC data for the instant lottery ticket to the POS system terminal. In various such embodiments, the UPC code enables the POS system terminal to add an instant ticket lottery sale to a POS shopping cart. In various such embodiments, the memory device stores a plurality of instructions that when executed by the processor, cause the lottery terminal to: (a) responsive to receiving from lottery terminal scanner the lottery ticket related data related to a draw lottery ticket, create in real time draw game wager request data and transmit the draw game wager request data to a lottery central system; and (b) responsive to the scan data received by the lottery terminal from the lottery terminal scanner not comprising lottery ticket related data, transmit the scan data to the POS system terminal. In various such embodiments, the lottery ticket related data comprises a UPC barcode for the draw lottery ticket. In various such embodiments, the memory device stores a plurality of instructions that when executed by the processor, cause the lottery terminal to, responsive to receiving from the lottery central system ticket draw game wager response data comprising a wager confirmation, transmit UPC data for the draw lottery ticket to the POS system terminal. In various such embodiments, the memory device stores a plurality of instructions that when executed by the processor, cause the lottery terminal to, responsive to receiving from the lottery central system ticket draw game wager response data comprising a wager confirmation, cause a lottery system printer to print the draw lottery ticket. In various such embodiments, the UPC data enables the POS system terminal to add a draw lottery ticket sale to a POS shopping cart. In various such embodiments, the memory device stores a plurality of instructions that when executed by the processor, cause the lottery terminal to: (a) responsive to receiving from the lottery terminal scanner lottery ticket related data related to a lottery ticket, create in real time ticket redemption request data, and transmit the ticket redemption request data to a lottery central system; and (b) responsive to the scan data received by the lottery terminal from the lottery terminal scanner not comprising lottery ticket related data, transmit the scan data to the POS system terminal. In various such embodiments, the lottery ticket is one of an instant lottery ticket and a draw lottery ticket. In various such embodiments, the memory device stores a plurality of instructions that when executed by the processor, cause the lottery terminal to, responsive to receiving from the lottery central system ticket redemption response data, create and transmit UPC data for the lottery ticket to the POS system terminal. In various such embodiments, the UPC data for the lottery ticket enables the POS system terminal to add a lottery ticket redemption amount to a POS shopping cart. In various such embodiments, the ticket redemption response data comprises data relating to the lottery ticket and corresponding to one of: a no-win category, a low-tier win amount category, a mid-tier win amount category, and a high-tier win amount category. In various such embodiments, the UPC data for the lottery ticket corresponds to the low tier win amount category and enables the POS system terminal to add a lottery ticket redemption amount to a POS shopping cart.

It should further be appreciated from the above that various embodiments of the present disclosure provide a lottery terminal configured to be communicatively and operably connected to a POS system terminal of a POS system, the lottery terminal comprising: (1) a housing; (2) a display device supported by the housing; (3) a scanner connector supported by the housing and configured to enable the lottery terminal to be communicatively connectable to a lottery terminal scanner; (4) a POS system connector supported by the housing and configured to enable the lottery terminal to be communicatively connectable to the POS system terminal; (5) a data transmitter supported by the housing; (6) a data receiver supported by the housing; (7) a processor supported by the housing and communicatively connected to the scanner connector, the POS system connector, the data transmitter, and the data receiver; and (8) a memory device supported by the housing, wherein the memory device stores a plurality of instructions that when executed by the processor, cause the lottery terminal to: (a) receive scan data from a scan by the lottery terminal scanner; (b) responsive to the scan data not comprising lottery ticket related data, cause a display, by the display device, of an error message; and (c) responsive to receiving the scan data comprising lottery ticket related data, determine UPC data associated with the lottery ticket, and create and transmit the UPC data for the lottery ticket to the POS system terminal.

It should further be appreciated from the above that various embodiments of the present disclosure provide a lottery terminal configured to be communicatively and operably connected to a POS system terminal of a POS system, wherein the lottery terminal includes: (1) a housing; (2) a display device supported by the housing; (3) a scanner connector supported by the housing and configured to enable the lottery terminal to be communicatively connectable to a lottery terminal scanner; (4) a POS system connector supported by the housing and configured to enable the lottery terminal to be communicatively connectable to the POS system terminal; (5) a data transmitter supported by the housing; (6) a data receiver supported by the housing; (7) a processor supported by the housing and communicatively connected to the scanner connector, the POS system connector, the data transmitter, and the data receiver; and (8) a memory device supported by the housing, wherein the memory device stores a plurality of instructions that when executed by the processor, cause the lottery terminal to: (a) receive scan data from a scan by the lottery terminal scanner; (b) responsive to the scan data not comprising lottery ticket related data, cause a display, by the display device, of an error message; and (c) responsive to receiving the scan data comprising lottery ticket related data, and responsive to receipt of confirmation of activation of the lottery ticket by a central lottery system, transmit the UPC data for the lottery ticket to the POS system terminal.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

The claims are as follows:

1. A lottery terminal configured to be communicatively and operably connected to a POS system terminal of a POS system, the lottery terminal comprising:
a housing;
a scanner connector supported by the housing and configured to enable the lottery terminal to be communicatively connectable to a lottery terminal scanner;
a POS system connector supported by the housing and configured to enable the lottery terminal to be communicatively connectable to the POS system terminal;
a data transmitter supported by the housing;
a data receiver supported by the housing;
a processor supported by the housing and communicatively connected to the scanner connector, the POS system connector, the data transmitter, and the data receiver; and
a memory device supported by the housing.

2. The lottery terminal of claim 1, which includes a printer connector supported by the housing, the printer connector configured to enable the lottery terminal to be communicatively connected to be communicatively connectable to a lottery ticket printer.

3. The lottery terminal of claim 1, wherein the memory device stores a plurality of instructions that when executed by the processor, cause the lottery terminal to receive scan data from a scan by the lottery terminal scanner.

4. The lottery terminal of claim 3, wherein the memory device stores a plurality of instructions that when executed by the processor, cause the lottery terminal to:
responsive to receiving from the lottery ticket related scan data related to an instant lottery ticket, create in real time ticket activation request data, and transmit the ticket activation request data to a lottery central system; and
responsive to the scan data received by the lottery terminal from the lottery terminal scanner not comprising lottery ticket related data, transmit the scan data to the POS system terminal.

5. The lottery terminal of claim 4, wherein the lottery ticket related data comprises I2of5 content.

6. The lottery terminal of claim 4, wherein the memory device stores a plurality of instructions that when executed by the processor, cause the lottery terminal to, responsive to receiving from the lottery central system ticket activation response data comprising a ticket activation confirmation, determine UPC data associated with the instant lottery ticket, and create and transmit the UPC data for the instant lottery ticket to the POS system terminal.

7. The lottery terminal of claim 6, wherein the UPC code enables the POS system terminal to add an instant ticket lottery sale to a POS shopping cart.

8. The lottery terminal of claim 3, wherein the memory device stores a plurality of instructions that when executed by the processor, cause the lottery terminal to:
responsive to receiving from lottery terminal scanner the lottery ticket related data related to a draw lottery ticket, create in real time draw game wager request data and transmit the draw game wager request data to a lottery central system; and
responsive to the scan data received by the lottery terminal from the lottery terminal scanner not comprising lottery ticket related data, transmit the scan data to the POS system terminal.

9. The lottery terminal of claim 8, wherein the lottery ticket related data comprises a UPC barcode for the draw lottery ticket.

10. The lottery terminal of claim 8, wherein the memory device stores a plurality of instructions that when executed by the processor, cause the lottery terminal to, responsive to receiving from the lottery central system ticket draw game wager response data comprising a wager confirmation, transmit UPC data for the draw lottery ticket to the POS system terminal.

11. The lottery terminal of claim 10, wherein the memory device stores a plurality of instructions that when executed by the processor, cause the lottery terminal to, responsive to receiving from the lottery central system ticket draw game wager response data comprising a wager confirmation, cause a lottery system printer to print the draw lottery ticket.

12. The lottery terminal of claim 10, wherein the UPC data enables the POS system terminal to add a draw lottery ticket sale to a POS shopping cart.

13. The lottery terminal of claim 3, wherein the memory device stores a plurality of instructions that when executed by the processor, cause the lottery terminal to:
responsive to receiving from the lottery terminal scanner lottery ticket related data related to a lottery ticket, create in real time ticket redemption request data, and transmit the ticket redemption request data to a lottery central system; and
responsive to the scan data received by the lottery terminal from the lottery terminal scanner not comprising lottery ticket related data, transmit the scan data to the POS system terminal.

14. The lottery terminal of claim 13, wherein the lottery ticket is one of an instant lottery ticket and a draw lottery ticket.

15. The lottery terminal of claim 13, wherein the memory device stores a plurality of instructions that when executed by the processor, cause the lottery terminal to, responsive to receiving from the lottery central system ticket redemption response data, create and transmit UPC data for the lottery ticket to the POS system terminal.

16. The lottery terminal of claim 15, wherein the UPC data for the lottery ticket enables the POS system terminal to add a lottery ticket redemption amount to a POS shopping cart.

17. The lottery terminal of claim 15, wherein the ticket redemption response data comprises data relating to the lottery ticket and corresponding to one of: a no-win category, a low-tier win amount category, a mid-tier win amount category, and a high-tier win amount category.

18. The lottery terminal of claim 17, wherein the UPC data for the lottery ticket corresponds to the low tier win amount category and enables the POS system terminal to add a lottery ticket redemption amount to a POS shopping cart.

19. A lottery terminal configured to be communicatively and operably connected to a POS system terminal of a POS system, the lottery terminal comprising:
a housing;
a display device supported by the housing;
a scanner connector supported by the housing and configured to enable the lottery terminal to be communicatively connectable to a lottery terminal scanner;
a POS system connector supported by the housing and configured to enable the lottery terminal to be communicatively connectable to the POS system terminal;
a data transmitter supported by the housing;
a data receiver supported by the housing;
a processor supported by the housing and communicatively connected to the scanner connector, the POS system connector, the data transmitter, and the data receiver; and
a memory device supported by the housing, wherein the memory device stores a plurality of instructions that when executed by the processor, cause the lottery terminal to:
receive scan data from a scan by the lottery terminal scanner;
responsive to the scan data not comprising lottery ticket related data, cause a display, by the display device, of an error message; and
responsive to receiving the scan data comprising lottery ticket related data, determine UPC data associated with the lottery ticket, and create and transmit the UPC data for the lottery ticket to the POS system terminal.

20. A lottery terminal configured to be communicatively and operably connected to a POS system terminal of a POS system, the lottery terminal comprising:
a housing;
a display device supported by the housing;
a scanner connector supported by the housing and configured to enable the lottery terminal to be communicatively connectable to a lottery terminal scanner;
a POS system connector supported by the housing and configured to enable the lottery terminal to be communicatively connectable to the POS system terminal;
a data transmitter supported by the housing;
a data receiver supported by the housing;
a processor supported by the housing and communicatively connected to the scanner connector, the POS system connector, the data transmitter, and the data receiver; and
a memory device supported by the housing, wherein the memory device stores a plurality of instructions that when executed by the processor, cause the lottery terminal to:
receive scan data from a scan by the lottery terminal scanner;
responsive to the scan data not comprising lottery ticket related data, cause a display, by the display device, of an error message; and
responsive to receiving the scan data comprising lottery ticket related data, and responsive to receipt of confirmation of activation of the lottery ticket by a central lottery system, transmit the UPC data for the lottery ticket to the POS system terminal.
